(19) United States
(12) Patent Application Publication
(10) Pub. No.: US 2009/0161044 A1
(43) Pub. Date: Jun. 25, 2009

(54) Wide viewing angle circular polarizers

(76) Inventors: Zhibing Ge, Orlando, FL (US); Ruibo Lu, Orlando, FL (US); Thomas Xinzhang Wu, Orlando, FL (US); Shin-Tson Wu, Orlando, FL (US); Chao-Lien Lin, Tainan (TW); Nai-Chin Hsu, Tainan (TW)

Correspondence Address: TROP, PRUNER & HU, P.C., 1616 S. VOSS ROAD, SUITE 750, HOUSTON, TX, 77057-2631, US

(21) Appl. No.: 12/004,581

(22) Filed: Dec. 21, 2007

(51) Int. Cl. G02F 1/13363; G02F 1/1335

(52) U.S. Cl. 349/98; 349/118

(57) ABSTRACT

Apparatus, devices, systems, and methods for wide viewing angle circular polarizers in transmissive and transflective displays. A liquid crystal display configuration can include two stacked circular polarizers, a liquid crystal layer, and a compensator between one of the circular polarizer and the liquid crystal layer to partially or fully compensate the liquid crystal layer. One of the circular polarizer is formed of a linear polarizer and a uniaxial quarter-wave plate, and the other circular polarizer is formed of a linear polarizer, a uniaxial quarter-wave plate, and a biaxial film interposed therebetween.

### FIELD OF INVENTION

Embodiments of the present invention are related to design of circular polarizers, and more particularly to apparatus, devices, systems, and methods for wide viewing angle circular polarizers in transmissive and/or transflective liquid crystal displays.

### BACKGROUND

Liquid crystal displays (LCD) are widely used in TVs, desktop monitors, notebooks, and portable electronic devices, owing to their compact size, light weight, high image quality, and low power consumption. For LCDs, wide-viewing angle and high brightness (high light efficiency) are two demands. In addition, in some LCD applications, the panel may have both transmissive and reflective functions to gain both indoor and outdoor readability, which are mainly called transflective LCDs.

Currently, multi-domain vertical alignment (MVA) has become the major wide-view display technology for both transmissive and transflective LCDs. In a MVA cell as shown in FIG. 1A (cross-sectional view of a pixel), the liquid crystal molecules 118 are sandwiched between two glass substrates 110a and 110b, and are initially aligned substantially perpendicular to the substrates when no voltage is applied between the bottom electrode 112a and the top electrode 112b. The MVA cell 120 is further interposed between two linear polarizers 100a and 100b. On the top substrate 110b, protrusions 116 are formed to make the liquid crystal molecules nearby have a small pre-orientation. On the bottom substrate 110a, slits 114 are opened on the electrode 112a. When a high voltage is applied between the top and bottom electrodes, the electric fields as the dashed lines 122 shown in FIG. 1B will be generated due to the slits and protrusions. As a result, the liquid crystal molecules at the left and right sides of the slits will tilt down towards different directions, forming a two-domain profile in the x-z plane. To further expand the viewing angle, a chevron typed protrusion and slit structure is developed for the MVA as shown in FIG. 1C (a top view of a pixel and in the x-y plane). Here the protrusions 116 formed on the top substrate and slits 114 on the bottom substrates have two divisions in the x-y plane: one in the upper half x-y plane and another in the bottom half x-y plane. Consequently, the liquid crystal molecules are distributed in four major domains: 130 and 132 in the bottom division, and 134 and 136 in the upper division. The four-domain structures are formed as shown in FIG. 1D at 45°, 135°, 225°, and 315°. The transmission axes 150a and 150b of the two linear polarizers are set at 0° and 90° to gain maximum light efficiency.

Under crossed linear polarizers, the transmittance for a retardation film with a total phase retardation value δ and its optic axis at an angle ø with respect to the transmission axis of one linear polarizer can be characterized by:

$$T = {sin}^{2} ( 2 φ ) {sin}^{2} ( \frac{δ}{2} ) . \qquad ( 1 )$$

Therefore, the transmittance is highly dependent on the orientation angle ø of the liquid crystal domains. From Eq. (1), T has a maximum value at ø=45°, 135°, 225°, and 315°. However, in the voltage-on state of a conventional MVA cell the liquid crystal molecules in the domain transition region 140, as shown in FIG. 1C, will not be confined exactly along the four major directions (45°, 135°, 225°, and 315°). As a result, the light efficiency of the MVA cell under crossed linear polarizers is reduced as compared to the conventional twist nematic LCD with single domain using plane electrodes. On the other hand, when using circular polarizers the transmittance of a MVA cell will only rely on the phase retardation value as:

$$T = {sin}^{2} ( \frac{δ}{2} ) . \qquad ( 2 )$$

Therefore, these molecules in the domain transition regions 140 will also contribute to the overall transmittance leading to a higher optical efficiency.

The schematic structure of a conventional display 201 is shown in FIG. 2A. A typical circular polarizer 280a (or 280b) consists of a linear polarizer 200a (or 200b) and a quarter-wave plate 260a (or 260b) with its optic axis aligned at 45° with respect to the transmission axis of the linear polarizer. Both of the quarter-wave plates are usually made of same typed uniaxial A plates, such as positive uniaxial A plates or negative A plates. Under such a configuration, when no voltage is applied to the MVA cell as shown in FIG. 2B, the liquid crystal molecules 218 are all vertically aligned, showing no phase retardation in the vertical direction. The incident light from the bottom backlight unit 290 will first become a linearly polarized light 205 that is parallel to the transmission axis 201a of the bottom polarizer 200a; with the optic axis of the first quarter-wave plate 260a at 45° away from the transmission axis 201a, the linearly polarized light 205 will then be converted to a circularly polarized light 215 with a first handedness (e.g., a left-handed circular polarization). Light 215 will keep its polarization state after passing through the vertically aligned liquid crystal cell 220. The top quarter-wave plate 260b then converts light 215 back to a linearly polarized light 225, whose polarization direction is perpendicular to the transmission axis 201b of the top linear polarizer 200b, and is blocked to result in a dark state.

On the other hand, as shown in FIG. 2C, when a high voltage is applied to liquid crystal cell 220, all the molecules 218 will substantially tilt down, making the cell 220 perform like a half-wave plate. Under such a condition, the circularly polarized light 215 with a first handedness (e.g., a left-handed circular polarization) from the bottom circular polarizer 280a will be converted to a circularly polarized light 235 with a second handiness (e.g., a right-handed circular polarization). The top quarter-wave plate further converts the light 235 with that second handedness to a linearly polarized light 245, whose polarization direction is parallel to the transmission axis 201b of the top linear polarizer 200b, resulting in a bright state.

However, under such a circumstance, only at a normal incidence, the circular polarizers in this design can produce a minimized light leakage. When viewed at an off-axis incidence, the light leakages are severe that result from two sources: 1) the change of effective angle of the two crossed linear polarizers, i.e., the transmission axes of the bottom and top linear polarizers will no longer be perpendicular to each other at most off-axis viewing directions; and 2) the non-compensable off-axis phase retardation from the two same typed uniaxial quarter-wave plates. The reasons for light leakage can be depicted by tracing the polarization state of the incident light through this system on a Poincaré sphere.

The off-axis light leakage in this type of crossed circular polarizers is severe. Such light leakage from barely two circular polarizers can reach 1% at around 35° and 10% at around 60°, which narrows the viewing angle (defined as a cone with a contrast ratio ≧10:1) of a MVA to 60°, and is inadequate for LCDs that require wide-viewing angle.

Other structures use multiple biaxial films to expand the viewing angle. However, these films make such designs more complex and higher cost, and it is difficult to accurately control the formation of biaxial films.

On another aspect, the multi-domain vertical alignment (MVA) is also widely used in transflective LCDs in which a circular polarizer is employed to achieve a dark state of the reflective mode. As shown in FIG. 3, a transflective MVA cell 496 having a separate transmissive region 495a and a reflective region 495b are sandwiched between two circular polarizers 490a and 490b. Therefore, the transmissive part 495a is also sandwiched between two circular polarizers.

From the analysis above, current approaches for circular polarizer structures are unsatisfying for both transmissive and transflective displays using multi-domain vertically aligned liquid crystals with a wide viewing angle.

### SUMMARY OF THE INVENTION

Embodiments may provide apparatus, devices, systems, and methods for circular polarizers that can have wide viewing angles for transmissive and transflective liquid crystal displays. Such apparatus, devices, systems, and methods can also enhance the brightness of a liquid crystal display using multi-domain vertically aligned liquid crystal displays.

Further objects and advantages of this invention will be apparent from the following detailed description of preferred embodiments which are illustrated schematically in the accompanying drawings.

### BRIEF DESCRIPTION OF THE DRAWINGS

FIG. 1A is a cross view of a prior art multi-domain vertically aligned liquid crystal cell at off state.

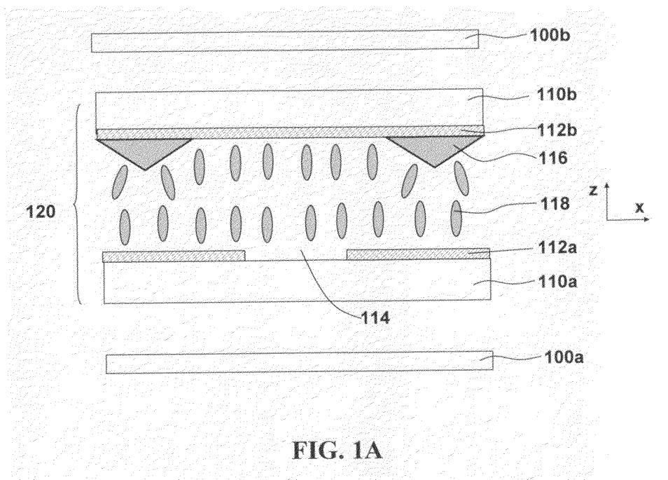

FIG. 1B is a cross view of a prior art multi-domain vertically aligned liquid crystal cell at on state.

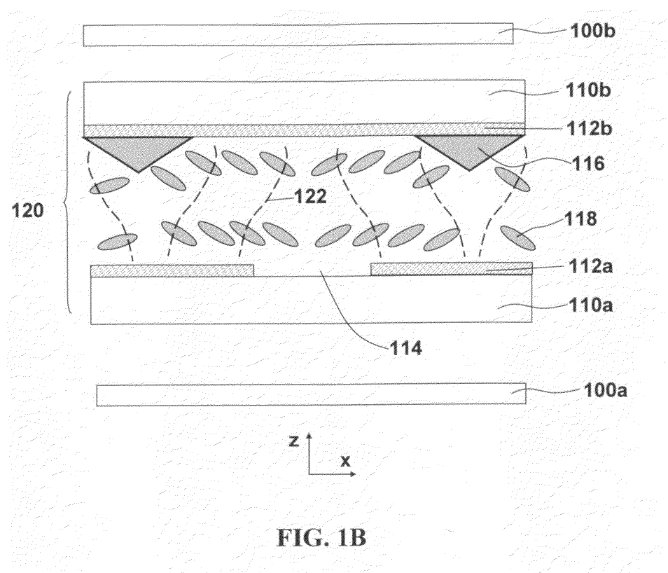

FIG. 1C is a top view of a prior art multi-domain vertically aligned liquid crystal cell.

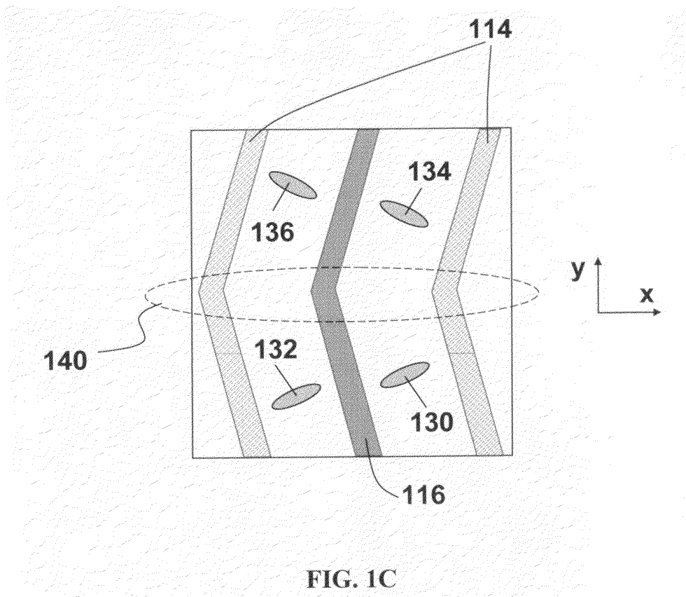

FIG. 1D is an illustration of the multi-domains.

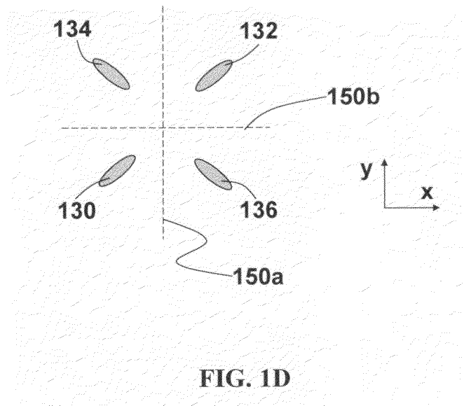

FIG. 2A is a conventional structure of circular polarizers for the MVA cell.

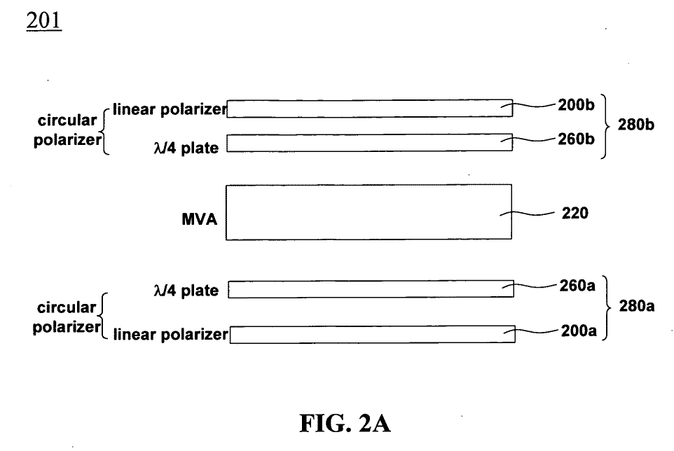

FIG. 2B illustrates the mechanism for a dark state.

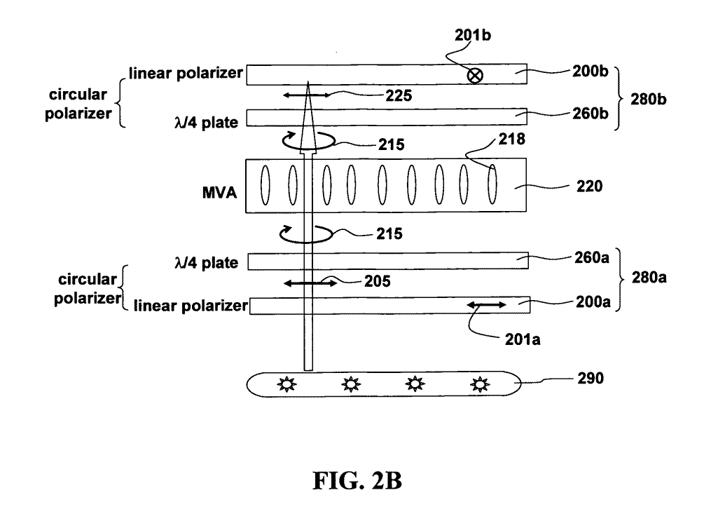

FIG. 2C illustrates the mechanism for a bright state.

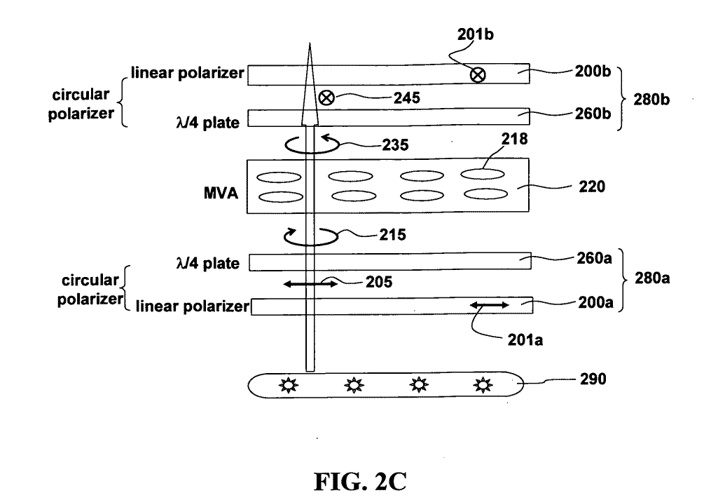

FIG. 3 is the schematic structure of circular polarizers for a transflective MVA cell.

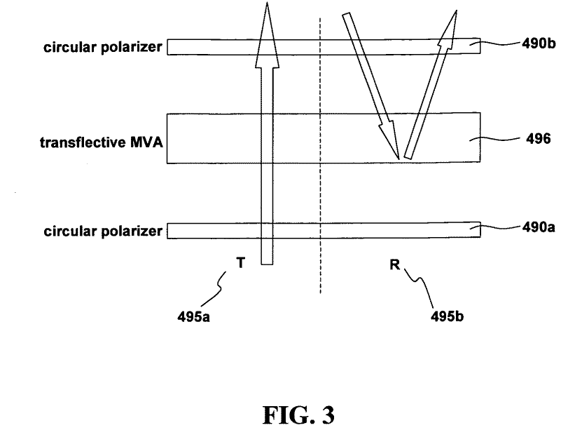

FIG. 4A is the schematic structure of circular polarizers for MVA cell of a first embodiment of the present invention.

FIG. 4B illustrates the optic axis orientation of each layer in the first embodiment.

FIG. 5A illustrates the mechanism for a dark state for the first embodiment.

FIG. 5B illustrates the mechanism for a bright state for the first embodiment.

FIG. 6 illustrates the viewing direction definition.

FIG. 7A illustrates the compensation mechanism for the first embodiment at one off-axis direction.

FIG. 7B illustrates the compensation mechanism for the first embodiment at another off-axis direction.

FIG. 8A is the angular light leakage.

FIG. 8B is the angular contrast ratio.

FIG. 9 illustrates the compensation mechanism for the first embodiment at one off-axis direction.

FIG. 10 illustrates the angular light leakage.

FIG. 11 is the spectral phase retardation value of one uniaxial film.

FIG. 12 is the schematic structure of the circular polarizers applied into a transflective MVA cell that has both transmissive and reflective functions.

FIG. 13 is the schematic structure of circular polarizers for MVA cell of a second embodiment of the present invention.

FIG. 14A illustrates the compensation mechanism for the second embodiment at one off-axis direction.

FIG. 14B illustrates the compensation mechanism for the second embodiment at another off-axis direction.

FIG. 15A is the angular light leakage.

FIG. 15B is the angular light leakage.

FIG. 16 is the schematic structure of circular polarizers for MVA cell of another embodiment of the present invention.

FIG. 17 is a flow diagram of a method in accordance with an embodiment of the present invention.

### DETAILED DESCRIPTION

Before explaining the disclosed embodiments of the present invention in detail it is to be understood that the invention is not limited in its application to the details of the particular arrangements shown since the invention is capable of other embodiments. Also, the terminology used herein is for the purpose of description and not of limitation.

### Embodiment 1

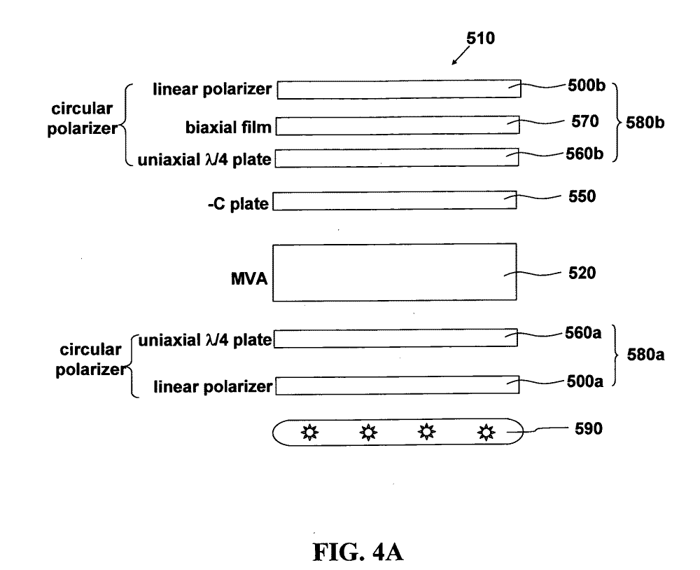

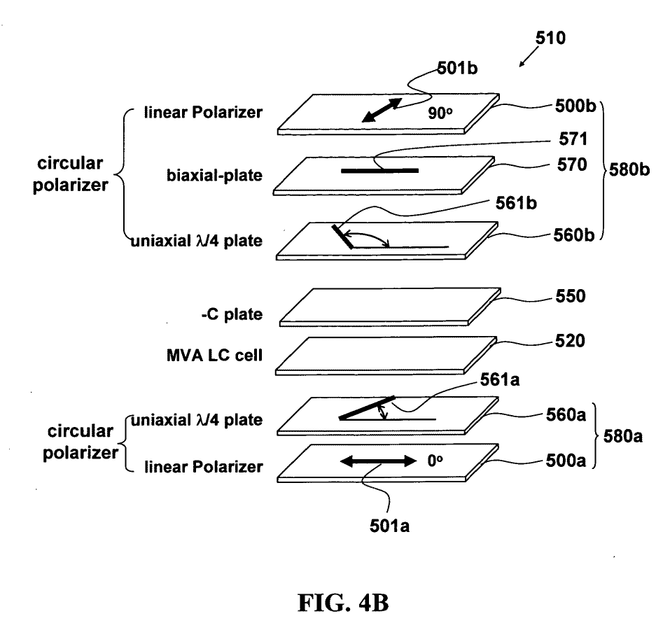

FIG. 4A is cross-sectional diagram of a first embodiment of the wide-view and circular polarizer configuration 510 for a MVA typed LCD. A MVA LCD cell 520 may include two glass substrates, vertically aligned liquid crystal layer, and electrodes, details of which are not shown in the embodiment of FIG. 4A. To enable attainment of different gray levels, a switching means such as a switching circuit may be coupled to LCD cell 520 to switch the phase retardation of the liquid crystal layer between substantially a zero and a half-wave plate value. The liquid crystal cell 520 may be sandwiched between a first circular polarizer 580a and a second circular polarizer 580b, where the first circular polarizer 580a includes a first linear polarizer 500a and a first uniaxial film based quarter-wave plate 560a; and the second circular polarizer 580b further includes a second linear polarizer 500b, a second uniaxial film based quarter-wave plate 560b, and a biaxial film 570 interposed between the second linear polarizer 500b and the second quarter-wave plate 560b.

Biaxial film 570 may be used to compensate off-axis light leakage and may have an N_{z} factor equal to

$$Nz = \frac{{n}_{x} - {n}_{z}}{{n}_{x} - {n}_{y}} ,$$

where nₓ, n_{y}, and n_{z} are refractive indices in the principal coordinates where the z-axis is perpendicular to the supporting glass substrates (and circular polarizers). Biaxial film 570 may be made of a two-dimensionally stretched polymeric film, and may have its nₓ axis aligned parallel to one of the absorption axes of the first and the second linear polarizers 500a and 500b. Linear polarizers 500a and 500b may include dichroic polymer films, such as a polyvinyl-alcohol-based film. A negative birefringent C film 550 (where nₓ, n_{y}>n_{z}, i.e., (nₓ+n_{y})/2>n_{z}, and Δn_{c}=n_{z}−(nₓ+n_{y})/2) is interposed between the MVA cell 520 (like a positive C film where nₓ=n_{y}<n_{z}, and Δn=n_{z}−nₓ) and second circular polarizer 580b to partially compensate the phase retardation from the MVA LC cell. The LCD panel is illuminated by the backlight unit 590.

The alignment of optic axis for each layer is illustrated in FIG. 4B. The transmission axis 501a of the first linear polarizer 500a is set at 0 degrees as a reference direction, and the transmission axis 501b of the second linear polarizer 500b is set perpendicular to the transmission axis of the first linear polarizer. Both the first uniaxial quarter-wave plate 560a and the second uniaxial quarter-wave plate 560b are made of same typed uniaxial films, such as a polymer layer having a stretched polymer film or a homogeneous liquid crystal film. According to the film type, both films can be positive uniaxial A films with their nₓ>n_{y}=n_{z}, or both can be negative A film with their nₓ<n_{y}=n_{z}. Such uniaxial quarter-wave plates may have a central wavelength with a range of between 450 nm to 600 nm. Here the first and second quarter-wave plates are perpendicular to each other; and at the same time each quarter-wave plate has its optic axis around 45° away from the transmission axis of the linear polarizer in the same circular polarizer group. More specifically, the optic axis 561a of the first quarter-wave plate 560a is set at around 45°, and the optic axis 561b of the second quarter-wave plate 560b is set at around 135°, which is around 45° away from the transmission axis 501b of the top linear polarizer 500b. The nₓ axis 571 of the biaxial film 570 is set at around 0°, which is perpendicular to the transmission axis 501b of the top linear polarizer 500b.

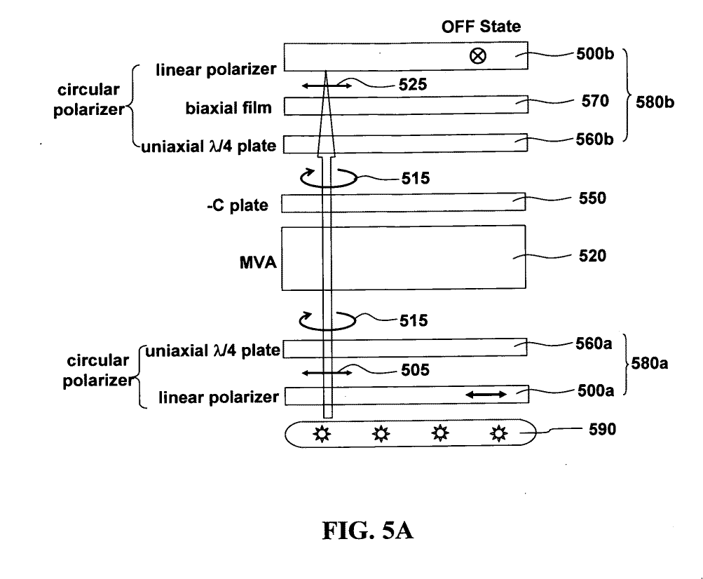

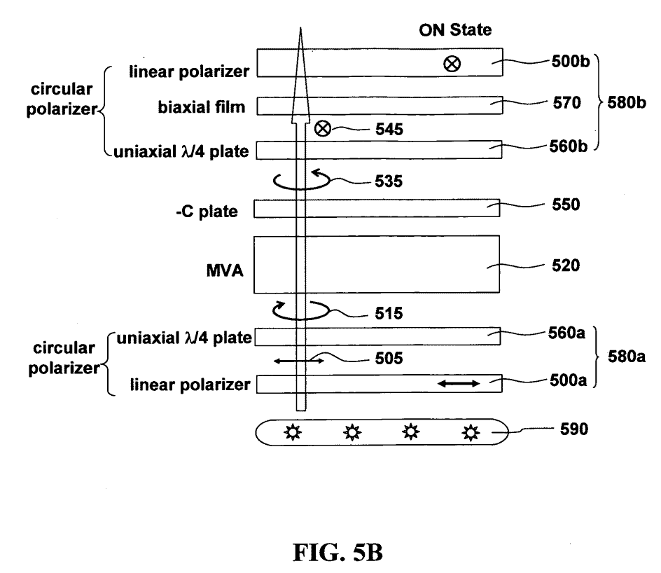

According to one embodiment of the invention, when no voltage is applied to the MVA LC cell, the liquid crystal molecules are substantially perpendicular to the glass substrates. That is, the liquid crystal layer is a vertically aligned liquid crystal cell with a negative dielectric anisotropy, where the liquid crystal molecules are initially aligned substantially perpendicular to the substrates. Therefore, the normal incident light will experience negligible phase retardation. As shown in FIG. 5A, when the incident light from the bottom backlight unit 590 passes through the first linear polarizer, it will be changed to a linearly polarized light 505 that is parallel to the transmission axis 501a of the first linear polarizer 500a; after it transmits through the first quarter-wave plate 560a, it will be transferred to a left-handed circularly polarized light 515; because of the negligible phase retardation from the LC cell (like a positive C film where nₓ=n_{y}<n_{z}, and Δn=n_{z}−nₓ) and the negative C plate (where nₓ, n_{y}>n_{z}, i.e., (nₓ+n_{y})/2>n_{z}, and Δn_{c}=n_{z}−(nₓ+n_{y})/2) at the normal incidence, the left-handed circularly polarized light 515 keeps its handedness all the way to the second quarter-wave plate 560b, and will be changed back by the second quarter-wave plate 560b to a linearly polarized light 525 that is perpendicular to the transmission axis of the top linear polarizer 500b, thus is blocked to reach a dark state.

When a high voltage through a thin-film-transistor (TFT) array (not shown here) is applied to the liquid crystal cell to make it equivalent to about a half-wave plate, the cell will appear white. As shown in FIG. 5B, the incident light from backlight 590 passing through the bottom linear polarizer will have a first linear polarization state as light 505; after it passes the first quarter-wave plate 560a, it will be transferred to a first left-handed circularly polarized light 515; and this left-handed circularly polarized light will be changed to a right-handed circularly polarized light 535 by the liquid crystal cell; and as it transmits the top quarter-wave plate 560b, it becomes a linearly polarized light 545 that is parallel to the transmission axis of the top linear polarizer 500b, thus a bright state is achieved. Here in both cases for the normal incidence, the polarization state of the light impinging on the bottom surface of the biaxial film 570 is either parallel or perpendicular to the nₓ axis of the biaxial film, thus it has no impact on changing the polarization of the lights at these polarizations.

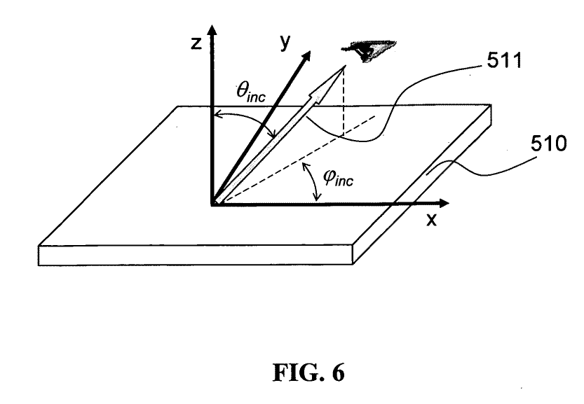

FIG. 6 illustrates the viewing direction 511 definition of a light to a viewer. At different azimuthal direction φ_{inc} and polar direction θ_{inc} to the display 510, the viewer will see a different polarization change of the light. As discussed above, two sources result in light leakages from the MVA cell using circular polarizers: 1) effective angle change of the bottom and top linear polarizers; and 2) the off-axis retardation from two quarter-wave plates. For a least light leakage, the compensations at two different directions φ_{inc}=0° and φ_{inc}=−45° need to be considered.

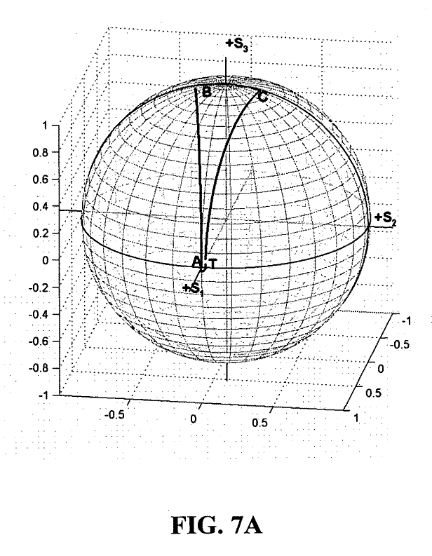

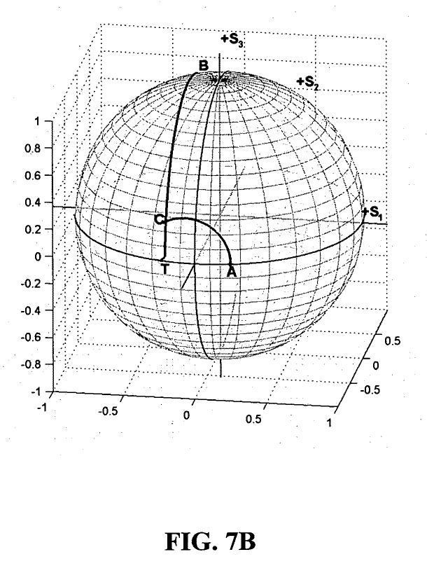

The present embodiment takes the following methods to suppress the off-axis light leakage of the display 510. Here the two quarter-wave plates 560a and 560b are set perpendicular to each other. When viewed at φ_{inc}=0° and θ_{inc}=70°, the transmission axis of the bottom linear polarizer 500a and the absorption axis of the top linear polarizer 500b are always perpendicular to each other at any polar angle. However, the optic axes of the two quarter-wave plates are no longer perpendicular to each other at this off-axis direction, which is the major reason for light leakage. In this embodiment, the liquid crystal cell 520 together with the negative C plate 550 work to compensate this relative angle change of the two quarter-wave plates. The polarization change on the Poincaré sphere when viewed at φ_{inc}=0° and θ_{inc}=70° is shown in FIG. 7A. At this direction, the transmission axis of the bottom polarizer at point T and the absorption axis of the top linear polarizer at point A overlapped with each other on the Poincaré sphere. In this case, the light passing through the first linear polarizer 500a will have a polarization state at T, and then is moved to point B by the quarter-wave plate 560a; the liquid crystal layer 520 and the negative C film 550 (negative C film is designed to partially compensate the phase retardation from the liquid crystal layer) together perform like a positive C film, which will transfer the light from polarization state at point B to point C; finally the top quarter-wave plate 560b will move the light from point C to point A. At this direction, the nₓ axis of the top biaxial film overlaps with point A and point T, and it will not change the polarization state of a light that has polarization direction at point A. Consequently, the light leakage at this direction is greatly suppressed.

Here for the present embodiment, the quarter-wave plate is centered at 550 nm. From the above analysis, the negative C plate 550 thus partially cancels the phase retardation from the MVA cell 520, and when the liquid crystal cell and the negative C film together behave like a positive C plate (where nₓ=n_{y}<n_{z}, and Δn=n_{z}−nₓ) whose overall phase retardation dΔn/λ is between approximately 0.1 to 0.2, the light leakage is minimized at this direction. The phase retardation value of the liquid crystal cell can be determined by the requirement for the bright state. On the bright state, the liquid crystal cell should behave like a half-wave plate. For a typical MVA cell, the liquid crystal molecules at the boundaries cannot be tilted completely by the pre-set on-state applied voltage. Therefore, the initial phase retardation value dΔn/λ (where Δn=nₑ−nₒ and nₑ and nₒ are the extraordinary and ordinary refractive index of the liquid crystal material, and λ is the wavelength of the incident light) of the LC cell would not be set at exactly a half-wave plate, e.g., dΔn/λ=½ or dΔn=275 nm for lambda at λ=550 nm. Usually, a MVA cell will have its initial dΔnₗ/λ at between approximately 0.45 to 0.70, or dΔnₗ˜247.5 nm to 385 nm at λ=550 nm. With abovementioned LC cell retardation, the phase retardation dΔn_{c}/λ of the negative C film (where nₓ, n_{y}>n_{z}, i.e., (nₓ+n_{y})/2>n_{z}, and Δn_{c}=n_{z}−(nₓ+n_{y})/2) is set at between approximately −0.60 to −0.25 (or dΔn between approximately −330 to −137.5 nm at λ=550 nm) to guarantee that the overall phase retardation of the liquid crystal cell and the negative C film is like a positive C plate (where nₓ=n_{y}<n_{z}, and Δn=n_{z}−nₓ) with dΔn/λ between approximately 0.1 to 0.2, i.e., a ratio of the phase retardation values, namely the absolute value of the phase retardation dΔn of the negative C plate over that of the LC layer ranges from ˜55.6% to ˜85.7%. The summary of these numbers is listed in Table I.

TABLE I

| | | |
|---|---|---|
| dΔnₗ/λ of LC cell* | 0.70 | 0.45 |
| dΔnₗ of LC cell* | 385 nm | 247.5 nm |
| dΔn_{c}/λ of negative C plate | −0.60 to −0.50 | −0.35 to −0.25 |
| (dΔn_{c} = [n_{z} − (nₓ + n_{y})/2] × d)* | | |
| dΔn_{c} of negative C plate | −330 nm to −275 nm | −192.5 nm to −137.5 nm |
| (dΔn_{c} = [n_{z} − (nₓ + n_{y})/2] × d)* | | |
| Rₜₕ of negative C plate/Δnd of LC cell (%) | 71.4% to 85.7% | 55.6% to 77.8% |
| (Rₜₕ(nm) = [(nₓ + n_{y})/2 − n_{z}] × d) | | |
| Combined phase retardation value Δnd/λ* | 0.1 to 0.2 | 0.1 to 0.2 |
| Residual Δnd/Δnd of LC cell (%) | 14.3% to 28.6% | 22.2% to 44.4% |

*at λ = 550 nm

On the other hand, when viewed from φ_{inc}=−45° and θ_{inc}=70°, these two uniaxial quarter-wave plates will always be perpendicular to each other and they can partially compensate their off-axis phase retardation by themselves; and the effective angle change of the two linear polarizers works as the major reason for the light leakage. At φ_{inc}=−45° and θ_{inc}=70°, the polarization change of the incident light through the display 510 is shown in FIG. 7B. At this direction, the transmission axis of the bottom linear polarizer is represented by the point T on the Poincaré sphere, while the absorption axis of the top linear polarizer is represented by the point A. And these two points depart from each other. In this embodiment, the film configuration automatically compensates this disparity and suppresses possible light leakage by including the biaxial film 570. The light passing through the first linear polarizer 500a will have a first linear polarization state on point T; it is then moved to point B by the first quarter-wave plate 560a. The liquid crystal cell 520, the following negative C film 550, and the second quarter-wave plate 560b together convert the light from point B back to point C; finally the biaxial film 570 moves the light from point C to point A, which is the absorption direction of the top linear polarizer 500b. Thus the light leakage at this direction can also be well suppressed.

From this polarization trace, once the phase retardation values of the two quarter-wave plates, the liquid crystal cell, and the negative C film are fixed, the position of point C will also be fixed. Thus the parameters of the biaxial film 570 can be adjusted to move the light from point C to point A. For the shape of arc AC in FIG. 7B, the optimized parameters of the biaxial film 570 are: Nz factor

$$( Nz = \frac{{n}_{x} - {n}_{z}}{{n}_{x} - {n}_{y}} )$$

approximately 0.35, in-plane retardation d(nₓ−n_{y})/λ approximately 0.35, and nₓ>n_{y}, although the scope of the present invention is not limited in this regard. In various embodiments, the liquid crystal cell is a transmissive liquid crystal cell, where an image of the liquid crystal display device is illuminated by a backlight unit.

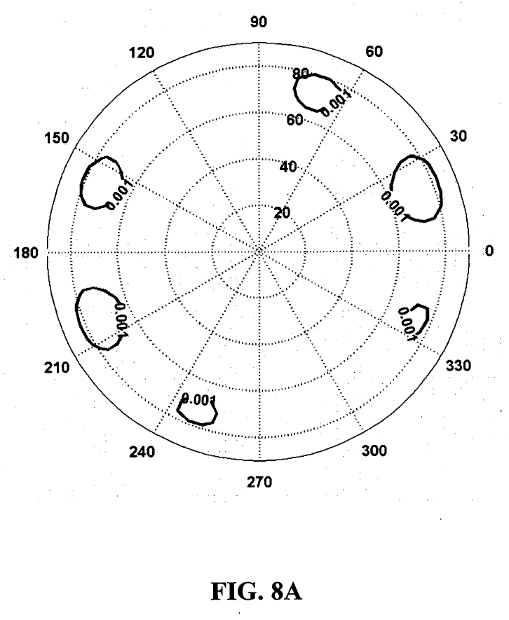

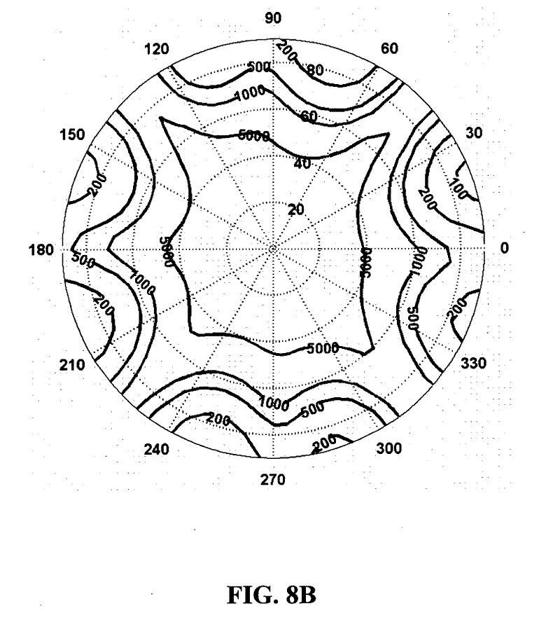

FIG. 8A shows the angular light leakage of the present embodiment. It can be seen that on the entire viewing cone, the light leakage of 0.001 (normalized to the maximum transmittance between two parallel linear polarizers) is expanded to over 60°, and the maximum light leakage is less than 0.0012. FIG. 8B shows the iso-contrast plot of the present embodiment, where contrast ratio over 100:1 is achieved on the entire viewing cone.

However, the biaxial film can have another solution to move the light from point C to point A from another direction. If nₓ<n_{y}, by setting Nz factor

$$( Nz = \frac{{n}_{x} - {n}_{z}}{{n}_{x} - {n}_{y}} )$$

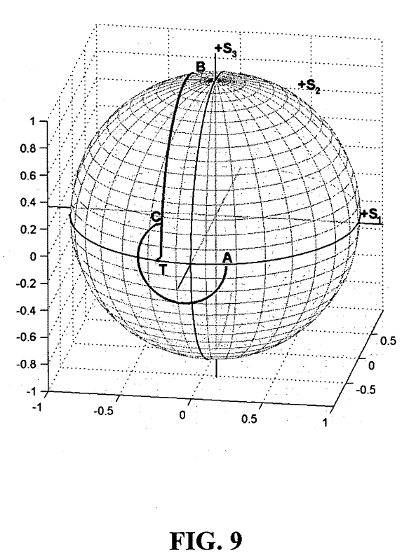

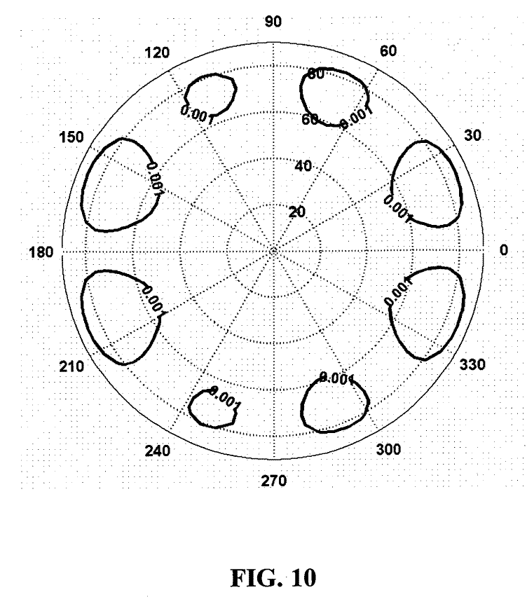

approximately 0.35, but in-plane retardation d(nₓ−n_{y})/λ approximately 0.65, the top biaxial film will rotate the light from point C to point A in the opposite direction as compared to that in FIG. 7B. The trace of polarization change on the Poincaré sphere is shown in FIG. 9, and its corresponding angular light leakage is shown in FIG. 10, where a small light leakage can also be achieved.

Besides the wide-viewing angle of this design, the brightness of the MVA cell under the circular polarizer is also greatly improved. It generates an overall transmittance around 30.5%, compared to the value of 23.3% when using sole crossed linear polarizers.

In addition, here in FIG. 4B, the optic axis 561a of the first quarter-wave plate 560a can also be set at −45°, which is 45° behind the transmission axis 501a of the bottom linear polarizer 500a. Correspondingly, the optic axis 561b of the second quarter-wave plate 560b is set at 45°, which is 45° behind the transmission axis 501b of the top linear polarizer 500b. Under such a condition, circular polarization can also be obtained, once a light passes the linear polarizer and the quarter-wave plate thereafter.

Here the negative C film 550 (where nₓ, n_{y}>n_{z}, i.e., (nₓ+n_{y})/2>n_{z}, and Δn_{c}=n_{z}−(nₓ+n_{y})/2) is used to make the LC layer (LC layer is like a positive C film where nₓ=n_{y}<n_{z}, and Δn=n_{z}−nₓ) and itself together to have an overall phase retardation like a positive C film (where nₓ=n_{y}<n_{z}, and Δn=n_{z}−nₓ). Therefore, the negative C film is not confirmed to be placed only between the MVA cell 520 and the top circular polarizer 580b; besides, it is also not confined that there is only one C film, an additional C film below the MVA cell can also be added, as long as the overall phase retardation from these C films and the liquid crystal layer is close to the optimized values discussed above.

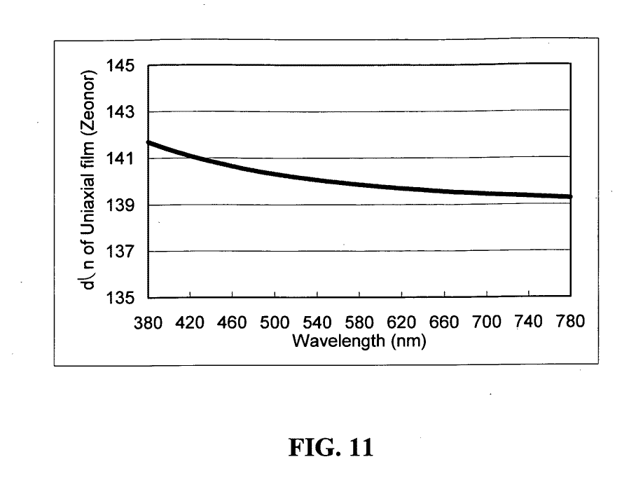

Different manners of selecting components for a display can occur. As one example, the liquid crystal cell, the quarter-wave plate and the biaxial film can first be selected, then the negative C plate is chosen accordingly. Another selection manner is to select the liquid crystal cell, the quarter-wave plate and the negative C plate first, and then choose the biaxial film. We can use the same quarter-wave plate that is centered at 550 nm. For example, FIG. 11 shows the relationship between the retardation values of the uniaxial film to the wavelength. The phase retardation value of the liquid crystal cell can be determined by the requirement for the bright state. On the bright state, the liquid crystal cell should behave like a half-wave plate. For a commercial MVA cell (e.g. liquid crystal material provided by Merck with Δnₗ=0.0934 and the cell gap is 4 μm) will have its initial dΔnₗ/λ at between approximately 0.679, dΔnₗ373.6 nm at λ=550 nm. Of course, a person with skill in the art can adjust the cell gap for the same liquid crystal material to obtain a different retardation value of the MVA cell (e.g. when the cell gap for this liquid crystal material is generally 4.0˜4.2±0.05 μm, the dΔnₗ/λ will from 0.671 to 0.721). For example, a commercial uniaxial film (e.g., Sumitomo's S-sina series, Zeonor) has its initial dΔn_{A}/2 at approximately 0.255(140 nm/550 nm), which is dΔn_{A}=R₀=(nₓ−n_{y})×d=140 nm at λ=550 nm (nₓ=1.5358, n_{y}=1.5316, n_{z}=1.5316 at 550 nm). And a commercial biaxial film (e.g. Nitto's coating C series) has its initial in-plane retardation dΔn_{b}/λ at approximately 0.491(270 nm/550 nm), where dΔn_{b}=270 nm at λ=550 nm and N_{z} factor

$$( Nz = \frac{{n}_{x} - {n}_{z}}{{n}_{x} - {n}_{y}} )$$

approximately 0.5.

Once the phase retardation values of the two quarter-wave plates, the liquid crystal cell, and the biaxial film are fixed, adjusting the thickness of the negative C-plate can be optimized to achieve a best contrast ratio at different viewing angles to the display. The optimized parameters of the negative C film 550 are Rₜₕ nm (Rₜₕ=[(nₓ+n_{y})/2−n_{z}]×d) approximately 242 nm, in-plane retardation Rₜₕ/λ approximately 0.44 (242/550). In various embodiments, the liquid crystal cell is a transmissive liquid crystal cell, where a backlight unit illuminates an image of the liquid crystal display device. With abovementioned LC cell retardation, the phase retardation dΔn_{c}/λ of the negative C film (where nₓ, n_{y}>n_{z}, i.e., (nₓ+n_{y})/2>n_{z}, and Δn_{c}=n_{z}−(nₓ+n_{y})/2) is set at between approximately −0.645 to =0.3 (or dΔn_{c} between approximately −355 to −165 nm at λ=550 nm) to guarantee that the overall contrast ratio of the liquid crystal device at 85° is greater than 10, e.g., a useable collocation. Also, the phase retardation dΔn_{c}/λ of the negative C film is set at between approximately −0.40 to −0.48 (or dΔn_{c} between approximately −265 to −218 nm at λ=550 nm) to guarantee that the overall contrast ratio of the liquid crystal device is greater than 10 at all viewing angles, e.g., a suggested collocation. Further, the phase retardation dΔn_{c}/λ of the negative C film is set at −0.44 (or dΔn_{c} at −242 nm at λ=550 nm) to make the overall contrast ratio of the liquid crystal device greater than 18 at all viewing angles and the overall contrast ratio of the liquid crystal device at 85° greater than 30, e.g., an optimum collocation. Therefore, from the above discussion, the overall phase retardation of the liquid crystal cell and the negative C film is like a positive C plate (where nₓ=n_{y}<n_{z}, and Δn=n_{z}−nₓ) with dΔn/λ between approximately 0.03 to 0.38, i.e., a ratio of phase retardation values, namely the absolute value of the phase retardation dΔn of the negative C plate over that of the LC layer, ranges from ˜44% to ˜95%. The summary of these conditions and corresponding numbers are listed in Table II.

TABLE II*

| | Useable | Suggested | Optimum | Suggested | Useable |
|---|---|---|---|---|---|
| | collocation | collocation | collocation | collocation | collocation |
| Thickness (μm) of negative C plate | 6 | 4.5 | 4.1 | 3.7 | 2.8 |
| dΔn_{c}/λ of negative C plate | −0.645 | −0.482 | −0.44 | −0.396 | −0.3 |
| (dΔn_{c} = [n_{z} − (nₓ + n_{y})/2] × d)* | | | | | |
| Rₜₕ of negative C plate | 355 | 265 | 242 | 218 | 165 |
| (Rₜₕ(nm) = [(nₓ + n_{y})/2 − n_{z}] × d) | | | | | |
| Rₜₕ of negative C plate/Δnₗd of LC | 95% | 71% | 65% | 58% | 44% |
| cell (%) | | | | | |
| Overall residual Δnd(nm) from | 18.6 | 108.6 | 131.6 | 155.6 | 208.6 |
| negative C plate and LC cell | | | | | |
| Combined phase retardation value | 0.03 | 0.2 | 0.24 | 0.28 | 0.38 |
| Δnd/λ (at 550 nm) | | | | | |
| Residual Δnd/Δnd of LC cell(%) | 5% | 29% | 34% | 42% | 56% |

*For biaxial film: R₀ = (nₓ − n_{y}) × d = 270 nm; N_{z} = (nₓ − n_{z})/(nₓ − n_{y}) = 0.5; second uniaxial film based quarter-wave plate: R₀ = (nₓ − n_{y}) × d = 140 nm; LC cell: Δnₗd = 373.6 nm at 550 nm, and first uniaxial film based quarter-wave plate: R₀ = (nx − ny) × d = 140 nm.

According to aforementioned descriptions in Table I and II, the different LC cell with And from 247.5 nm to 392.3 nm at a wavelength of 550 nm, the phase retardation dΔn_{c}/λ of the negative C film (where nₓ, n_{y}>n_{z}, i.e., (nₓ+n_{y})/2>n_{z}, and Δn_{c}=n_{z}−(nₓ+n_{y})/2) will be set from −0.645 to −0.25 to guarantee a wide viewing angle. Here there might have different suggested conditions for negative C plate with Rₜₕ from 355 to 137.5 nm at 550 nm. And the negative C plate partially cancels the phase retardation of the LC cell, making them together like a positive C plate in the display.

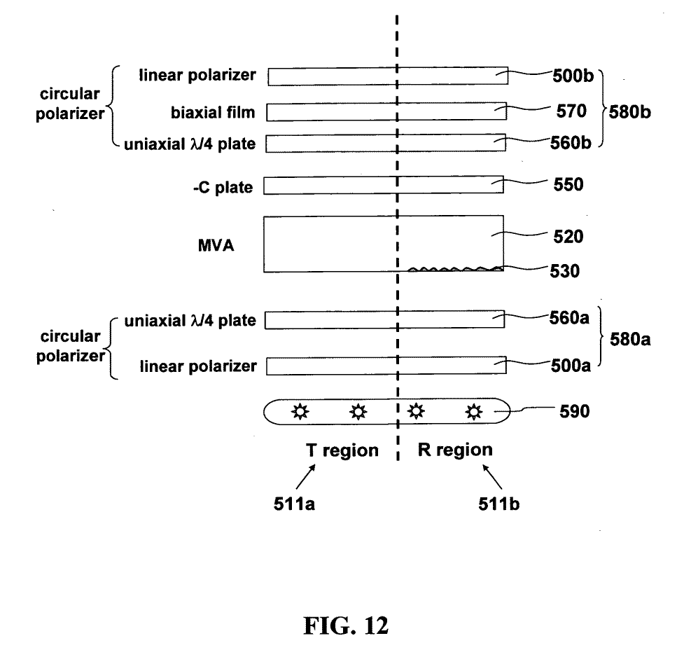

In addition, the MVA liquid crystal cell can also be a transflective liquid crystal cell that has both transmissive and reflective functions, wherein the reflective function is usually realized by adding a reflector to the bottom surface of the liquid crystal layer. The detailed display configuration is shown in FIG. 12, where each small pixel region is divided into a transmissive region 511 a and a reflective region 511b with a metal reflector 530. In such a case, the top circular polarizer can generate a normally dark state for the reflective mode (when the image is displayed by the ambient light). When no voltage is applied to the liquid crystal cell 520, all the molecules are substantially perpendicular to the substrates, resulting in a negligible phase retardation in the normal incidence. After the incident ambient light from the viewer's side transmits the top linear polarizer 500b, it first becomes a linearly polarized light that has a polarization parallel to the top polarizer's transmission axis 501b. After it passes the top quarter-wave plate 560b, it changes to a first circularly polarized light. Here the biaxial film has no effect on the linearly polarized incident light, owing to the fact that its nₓ is perpendicular to the transmission axis 501b. At the normal incidence, the light experiences negligible phase retardation throughout the C film and the liquid crystal cell, thus keeping the circular polarization all the way to the reflector surface. The metal reflector 530 will reflect the incident light and invert the handiness of the incident circularly polarized light (e.g., from a left-hand one to a right-hand one, vice versa, but the propagation direction is also inverted). After it is reflected back and transmits the top quarter-wave plate 560b again, it will be converted to a linearly polarized light that is parallel to the absorption direction of the top linear polarizer 500b, thus is blocked and results in a dark state for the reflective mode. On the other hand, if the LC layer is tuned to appear a phase change equivalent to a quarter-wave plate, the incident circularly polarized light (as a first circular polarization) from the top circular polarizer 580b will be transferred to a linearly polarized light by the liquid crystal layer before it reaches the reflector surface. Once it is reflected back by the reflector and passes the liquid crystal layer 520, it will be converted back to a circular polarization state, where after passing the top quarter-wave plate this circular polarization changes to a linear polarization that is parallel to the transmission axis of the top linear polarizer. As a result, this reflected light can transmit the top circular polarizer to achieve a bright state.

### Embodiment 2

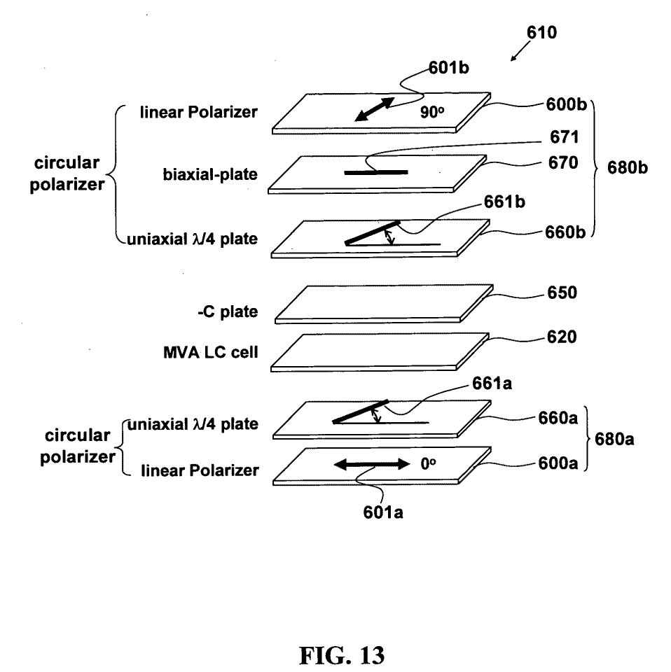

In a second embodiment of the present invention as shown in FIG. 13, the display 610 has a MVA cell 620 (including two glass substrates and the vertically aligned liquid crystal layer and the LC layer behaves like a positive C plate where nₓ=n_{y}<n_{z}, and Δn=n_{z}−nₓ) that is compensated by a negative C film 650 (where nₓ, n_{y}>n_{z}, i.e., (nₓ+n_{y})/2>n_{z}, and Δn=n_{z}−nₓ). The liquid crystal layer and the C film are sandwiched between a first circular polarizer 680a and a second circular polarizer 680b. The first circular polarizer 680a includes a first linear polarizer 600a and a uniaxial quarter-wave plate 660a, and the second circular polarizer includes a second linear polarizer 600b, a biaxial film 670, and a second uniaxial quarter-wave plate 660b. The transmission axis 601a of the first polarizer 600a is set at 0° as a reference direction and the transmission axis 601b of the top linear polarizer 600b is perpendicular to the transmission direction 601a, i.e., at 90°.

Different from abovementioned embodiments, the first uniaxial axial quarter-wave plate 660a and the second uniaxial quarter-wave plate 660b are made of opposite typed uniaxial films, such as a positive uniaxial A film with its nₓ>n_{y}=n_{z} for one quarter-wave plate 660a, and a negative A film with its nₓ<n_{y}=n_{z} for the other quarter-wave plate 660b, or vice versa. Under such a condition, the optic axis 661b of the second quarter-wave plate 660b is set parallel to the optic axis 661a of the first quarter-wave plate 660a. Similarly the optic axis of each quarter-wave plate is set at 45° with respect to the transmission axis of its nearby linear polarizer. In other words, both the optic axis 661a and the optic axis 661b can be set equal and be at around 45° or around −45°. And the nₓ axis 671 of the biaxial film is perpendicular to the transmission axis 601b of the top linear polarizer 600b.

Different from abovementioned compensation schemes in the first embodiment, the optic axes of two quarter-wave plates in this case are always parallel to each other at any off-axis angle to warrant a complete self-compensation. Thus the negative C film 650 is designed to fully compensate the phase retardation of the MVA cell 620. In this case, the light leakage from the MVA cell using circular polarizers comes mainly from effective angle change of the bottom and top linear polarizers, which can be compensated by the biaxial film 670.

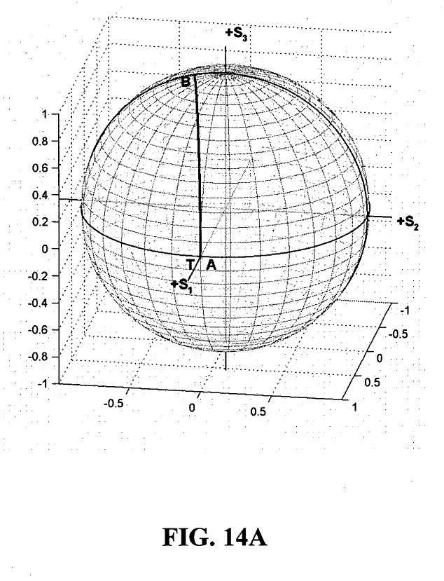

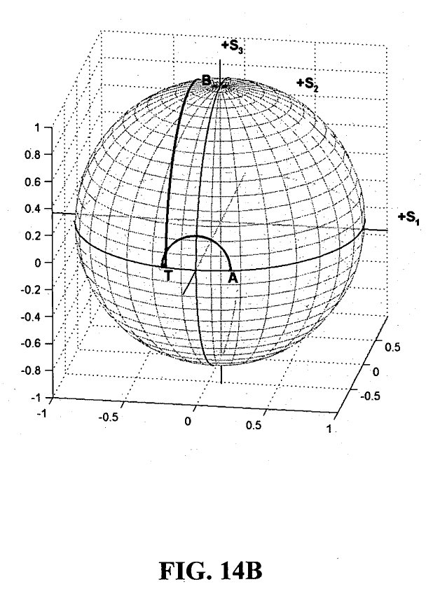

FIG. 14A shows the polarization trace on the Poincaré sphere of the incident light through the display 610, when viewed at φ_{inc}0° and θ_{inc}=70°. At this direction, the transmission direction of the bottom linear polarizer at point T overlaps with the absorption direction of the top linear polarizer at point A. The bottom quarter-wave plate 660a moves the light from point T to point B first; once the negative C film 650 completely cancels the phase retardation from the liquid crystal layer 620, the top quarter-wave plate 660b can move the light from point B back to point A. The biaxial film 670 having its nₓ axis also at point T will not change the polarization of the light at point A. Consequently, the light leakage at this viewing direction is greatly suppressed.

When viewed at φ_{inc}=−45° and θ_{inc}=70°, the polarization trace on the Poincaré sphere when is shown in FIG. 14B. Here the transmission direction of the bottom linear polarizer at point T departs from the absorption direction of the top linear polarizer at point A. Here the light with its initial polarization state at point T will be converted to point B by the first quarter-wave plate 660a. Because the negative C film 650 is designed to almost completely compensate the phase retardation of the liquid crystal layer 620, the light will keep its polarization state at point B after passing the liquid crystal layer and the C film. Since the second quarter-wave plate 660b has an opposite birefringence, it will move the polarization from point B to point T. Finally, the biaxial film moves the light from point T to point A, thus light leakage at off-axis is suppressed.

Similarly, the phase retardation value dΔn/λ of the MVA cell is determined by the requirement for its bright state, that is usually between approximately 0.45 to 0.70, or dΔn approximately 247.5 nm to 385 nm at λ=550 nm. With abovementioned LC cell retardation, the phase retardation dΔn/λ of the negative C film (where nₓ, n_{y}>n_{z}, i.e., (nₓ+n_{y})/2>n_{z} and Δn=n_{z}−nₓ) is between −0.8 to −0.35 (or dΔn approximately −440 to −192.5 nm at λ=550 nm) to guarantee that the overall phase retardation dΔn/λ of the liquid crystal cell and the negative C film is approximately −0.1 to 0.1. And the biaxial film has its N_{z} factor

$$( Nz = \frac{{n}_{x} - {n}_{z}}{{n}_{x} - {n}_{y}} )$$

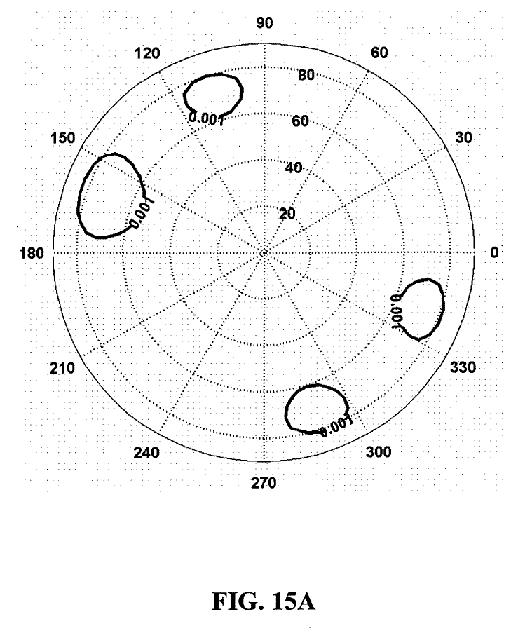

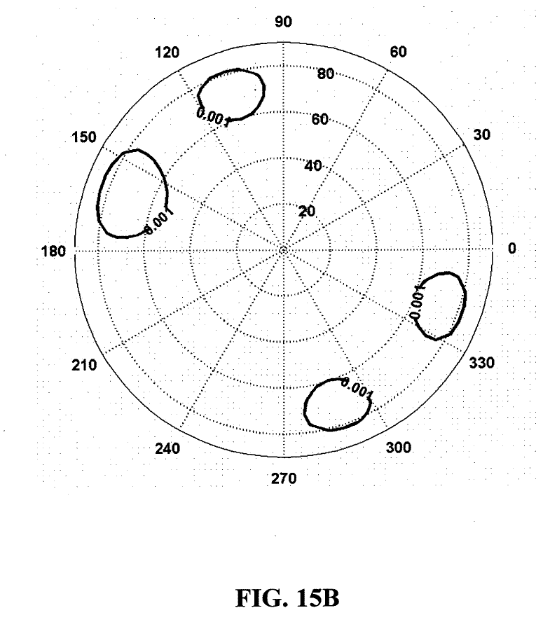

approximately 0.5 and in-plane retardation d(nₓ−n_{y})/λ approximately 0.5, and nₓ>n_{y}. For the present parameters, the angular light leakage is shown in FIG. 15A, where the light leakage over 0.001 is greatly suppressed to over 60°. Once the nₓ<n_{y} is set for the biaxial film, it can also compensate the effective angle change of the two linear polarizers, and its angular light leakage is shown in FIG. 15B.

Similarly, the negative C film 650 is used to compensate the phase retardation of the LC layer. Therefore, the negative C film is not restricted to be placed only between the MVA cell 620 and the top circular polarizer 680b. Besides, it is also not restricted to use only one C film; an additional C film below the MVA cell can also be added, as long as the overall phase retardation from these C films and the liquid crystal layer is close to the optimized values discussed above.

In addition, the MVA liquid crystal cell can also be a transflective liquid crystal cell that has both transmissive and reflective functions, wherein the reflective function is usually realized by adding a reflector to the bottom surface of the liquid crystal layer. The mechanism of this circular configuration applied into a transflective liquid crystal display is similar to abovementioned discussion for Embodiment 1.

### Embodiment 3

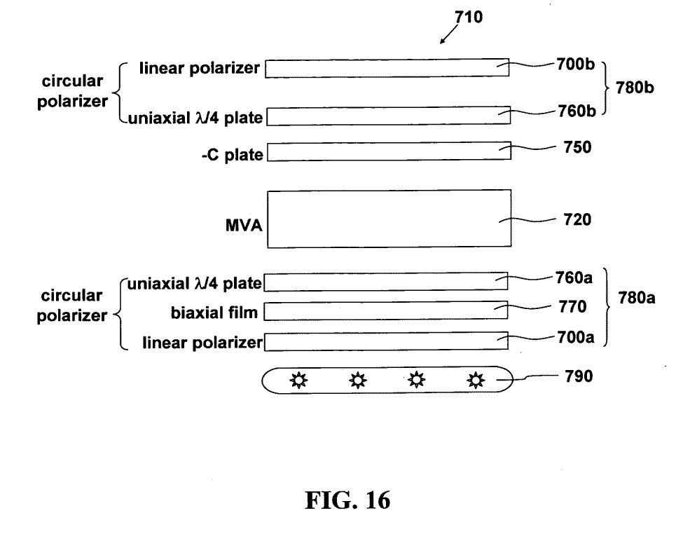

Yet in another embodiment of the present invention as shown in FIG. 16, the display 710 has a MVA cell 720 (including two glass substrates and the vertically aligned liquid crystal layer) sandwiched between a first circular polarizer 780a and a second circular polarizer 780b, wherein the first circular polarizer 780a is closer to the backlight unit 790 and the second circular polarizer 780b is closer to the viewer's side. A negative C film 750 is sandwiched between the MVA cell 720 and one of the circular polarizers.

The first circular polarizer 780a includes a first linear polarizer 700a, a biaxial film 770, and a first uniaxial quarter-wave plate 760a; and the second quarter-wave plate 780b includes a second linear polarizer 700b and a second quarter-wave plate 760b. Different from the discussed embodiments, here the biaxial film 770 is placed between the first linear polarizer and the first quarter-wave plate that are closer to the backlight unit. These two linear polarizers have their transmission axes perpendicular to each other. The biaxial film is employed to compensate the off-axis phase retardation resulting from the disparity of the transmission direction of the first linear polarizer and the absorption axis of the second linear polarizer when viewed from an off-axis direction. And the two quarter-wave plates 760a and 760b, along with the C film 750 and the liquid crystal layer 720 are used to compensate their phase retardation by themselves.

Similarly, the negative C film is not confined to be placed only between the MVA cell 720 and the bottom circular polarizer 780a; besides, it is also not confined that there is only one C film, additional C film below the MVA cell can also be added, as long as the overall phase retardation from these C films and the liquid crystal layer is close to the optimized values discussed above.

In addition, the MVA liquid crystal cell can also be a transflective liquid crystal cell that has both transmissive and reflective functions, wherein the reflective function is usually realized by adding a reflector to the bottom surface of the liquid crystal layer. The mechanism of this circular configuration applied into a transflective liquid crystal display is similar to abovementioned discussion for Embodiment 1.

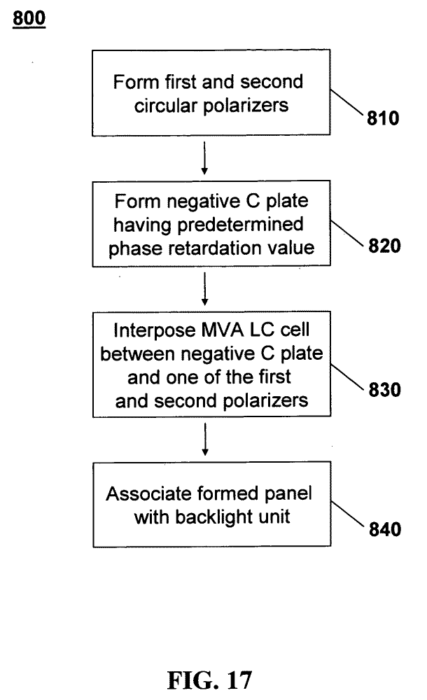

Referring now to FIG. 17, shown is a flow diagram of a method in accordance with an embodiment of the present invention. More specifically, FIG. 17 shows a method 800 for forming a LCD display device in accordance with the techniques described herein. It is to be understood that while shown with the particular steps set forth in FIG. 17, the scope of the present invention is not limited in this regard, and various other processes may be performed to obtain a LCD device having wide viewing angle circular polarizers in accordance with an embodiment of the present invention.

As shown in FIG. 17, method 800 may begin by forming first and second circular polarizers (block 810). More specifically, two circular polarizers may be formed, one of which includes a linear polarizer, a uniaxial quarter wave plate, and a biaxial film, while the second circular polarizer includes only a linear polarizer and a uniaxial quarter wave plate. Next a negative C plate may be formed having a predetermined phase retardation value (block 820). More specifically, a negative C film may be formed with a given phase retardation value that is determined based on the formed first and second circular polarizers. That is, as described above depending on whether the uniaxial quarter wave plates are aligned perpendicular to each other or parallel to each other, the phase retardation value of the negative C film may differ to enable the negative C film to either partially or to fully compensate the phase retardation of the MVA cell. More specifically, when the quarter wave plates are perpendicular to each other, partial compensation may be provided, while when the quarter wave plates are parallel to each other, a full phase retardation compensation may be provided.

Referring still to FIG. 17, the MVA cell may be interposed between the negative C plate and one of the first and second polarizers (block 830). As described above, the negative C plate can be interposed between the MVA cell and either of the first or second polarizers. Finally, to complete a functional LCD display device, a formed panel may be associated with a backlight unit (block 840). While shown with this particular implementation in the embodiment of FIG. 17, the scope of the present invention is not limited in this regard.

Thus embodiments of the present invention may attain wide viewing angle circular polarizers, which are quite promising for wide viewing angle, full color transmissive and transflective and transmissive LCDs.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A liquid crystal display device comprising:
a first circular polarizer including a first linear polarizer and a first quarter-wave plate;
a second circular polarizer including a second linear polarizer, a biaxial film, and a second quarter-wave plate, the biaxial film interposed between the second linear polarizer and the second quarter-wave plate;
a liquid crystal cell interposed between the first circular polarizer and the second circular polarizer; and
at least one optical retardation compensator disposed between the first circular polarizer and the second circular polarizer, wherein the optical retardation compensator is to partially compensate a phase retardation of the liquid crystal cell;
wherein the first linear polarizer and the second linear polarizer have their absorption axes substantially perpendicular to each other, the first and second quarter-wave plates are formed of uniaxial A films with optical refractive indices nₓ, n_{y}, and n_{z}, and the optic axis nₓ of the first quarter-wave plate is substantially perpendicular to the optic axis nₓ of the second quarter-wave plate, and the biaxial film has its optical refractive indices nₓ≠n_{y}≠n_{z}.

2. The display of claim 1, wherein the optic axis nₓ of the first quarter-wave plate is set at around 45° away from the absorption axis of the first linear polarizer.

3. The display of claim 1, wherein a range of a central wavelength of the first and second quarter-wave plates is between approximately 450 nm to 600 nm.

4. The display of claim 1, wherein the liquid crystal cell includes a vertically aligned liquid crystal layer with a negative dielectric anisotropy, wherein liquid crystal molecules of the liquid crystal layer are initially aligned substantially perpendicular to the first and second circular polarizers.

5. The display of claim 1, wherein the phase retardation value dΔnₗ/λ of the liquid crystal cell is set between 0.45 and 0.72.

6. The display of claim 1, wherein the optical retardation compensator between the first and second circular polarizers includes at least a negative uniaxial C film with optical refractive indices and an absolute phase retardation value dΔn_{c}/λ of the optical retardation compensator is less than the liquid crystal cell phase retardation value.

7. The display of claim 1, wherein a combined phase retardation value dΔn/λ together of the liquid crystal cell and the optical retardation compensator between the first and second circular polarizers ranges from approximately 0.03 to 0.38.

8. The display of claim 1, wherein an absolute value of the phase retardation value dΔn_{c}/λ of the optical retardation compensator between the first and second circular polarizers over the liquid crystal cell phase retardation value dΔnₗ/λ ranges from approximately 44% to 95%.

9. The display of claim 1, wherein the biaxial film in the second circular polarizer has its nₓ axis aligned parallel to one of the absorption axes of the first and second linear polarizers, and the biaxial film is the only biaxial film present in the display.

10. The display of claim 9, wherein the biaxial film has a Nz factor
$$( Nz = \frac{{n}_{x} - {n}_{z}}{{n}_{x} - {n}_{y}} )$$
between approximately 0.1 and 0.6 and an in-plane phase retardation value of between approximately 0.2 and 0.8.

11. The display of claim 1, wherein the liquid crystal cell is a transmissive liquid crystal cell and an image of the liquid crystal display device is illuminated by a backlight unit.

12. The display of claim 1, wherein the liquid crystal cell is a transflective liquid crystal display, wherein the liquid crystal display device has both transmissive and reflective functions, and an image of the liquid crystal display device is illuminated by a backlight unit for the transmissive function and by an ambient light for the reflective function.

13. The display of claim 1, wherein the uniaxial A films comprise positive A films having its optical reflective indices nₓ>n_{y}=n_{z}.

14. A liquid crystal display comprising:
a first circular polarizer having a first linear polarizer and a first quarter-wave plate;
a second circular polarizer having a second linear polarizer, a biaxial film, and a second quarter-wave plate, the biaxial film interposed between the second linear polarizer and the second quarter-wave plate;
a first substrate;
a second substrate;
a liquid crystal cell sandwiched between the first and second substrates, wherein the liquid crystal cell and the substrates are further interposed between the first and second circular polarizers;
at least one optical retardation compensator disposed between the first and second circular polarizers; and
a switching circuit coupled to the liquid crystal cell to switch a phase retardation of a liquid crystal layer of the liquid crystal cell substantially between a zero and a half-wave plate value, wherein the first linear polarizer and the second linear polarizer have their absorption axes substantially perpendicular to each other, one of the first and second quarter-wave plates is made of a uniaxial positive A film with optical refractive indices nₓ>n_{y}=n_{z} and the other is made of a uniaxial negative A film with optical refractive indices nₓ<n_{y}=n_{z}, the optic axis nₓ of the first quarter-wave plate is substantially parallel to the optic axis nₓ of the second quarter-wave plate, and the biaxial film has its optical refractive indices nₓ≠n_{y}≠n_{z}.

15. The display of claim 14, wherein the optic axis nₓ of the first quarter-wave plate is set at around 45° away from the absorption axis of the first linear polarizer.

16. The display of claim 14, wherein a phase retardation value dΔn/λ of the liquid crystal layer is set at between approximately 0.45 to 0.70.

17. The display of claim 16, wherein the optical retardation compensator between the first and second circular polarizers includes at least a negative uniaxial C film with optical refractive indices, and wherein a phase retardation value of the negative uniaxial C film is to substantially cancel the phase retardation value of the liquid crystal layer.

18. The display of claim 14, wherein a combined phase retardation value of the liquid crystal layer and the optical retardation compensator between the first and second circular polarizers ranges from approximately −0.1 to 0.1.

19. The display of claim 14, wherein the biaxial film in the second circular polarizer has its nₓ axis aligned parallel to one of the absorption axes of the first and second linear polarizers, and the biaxial film is the only biaxial film present in the display.

20. The display of claim 19, wherein the biaxial film has an Nz factor
$$( Nz = \frac{{n}_{x} - {n}_{z}}{{n}_{x} - {n}_{y}} )$$
of between approximately 0.3 to 0.7, and an in-plane phase retardation value of between approximately 0.35 to 0.65.

21. A method comprising:
forming a first circular polarizer having a first linear polarizer and a first quarter-wave plate;
forming a second circular polarizer having a second linear polarizer, a biaxial film, and a second quarter-wave plate, the biaxial film interposed between the second linear polarizer and the second quarter-wave plate;
interposing a negative compensation film having optical refractive indices (nₓ+n_{y})/2>n_{z} between the first and second circular polarizers; and
interposing a liquid crystal cell between the negative compensation film and one of the first and second circular polarizers to form a liquid crystal display, wherein the negative compensation film is to partially compensate for a phase retardation of the liquid crystal cell.

22. The method of claim 21, wherein a phase retardation value dΔn/λ of a liquid crystal layer of the liquid crystal cell is set at between approximately 0.45 to 0.72 and a combined phase retardation value of the liquid crystal layer and the negative compensation film is between approximately 0.03 to 0.38.

23. The method of claim 21, further comprising aligning the nₓ axis of the biaxial film parallel to one of the absorption axes of the first and second linear polarizers, and wherein the biaxial film is the only biaxial film present in the liquid crystal display.

24. The method of claim 23, further comprising forming the biaxial film having a Nz factor
$$( Nz = \frac{{n}_{x} - {n}_{z}}{{n}_{x} - {n}_{y}} )$$
of between approximately 0.1 and 0.7, and an in-plane phase retardation value of between approximately 0.2 and 0.8.

25. The method of claim 21, further comprising forming the liquid crystal display with a backlight unit, wherein the backlight unit is adjacent to the second circular polarizer, and the liquid crystal cell is interposed between the second circular polarizer and the negative compensation film.
